(19) United States
(12) Patent Application Publication
(10) Pub. No.: US 2008/0029018 A1
(43) Pub. Date: Feb. 7, 2008

(54) RV-EZ Flagpole

(76) Inventor: Gerald Mark Rehkopf, Shelby, MI (US)

Correspondence Address: GERALD MARK REHKOPF, 310 S. 108TH AVE., P.O. BOX 51, SHELBY, MI, 49455, US

(21) Appl. No.: 11/309,443

(22) Filed: Aug. 7, 2006

(51) Int. Cl. G09F 17/00

(52) U.S. Cl. 116/173

(57) ABSTRACT

A flagpole assembly that can be attached to the awning arm of most recreational vehicles, such as travel trailers and fifth wheel trailers. The flagpole is easily and securely attached without the aid of tools and without damaging hardware. The flagpole assembly can easily be completely removed and easily stowed when traveling. The flagpole brackets semi-encompass the awning arm and are held in place with stretch rings.

### BACKGROUND OF INVENTION

Prior attempts to supply the public with a flagpole suitable for mounting onto a recreational vehicle, such as campers, fifth wheels, and motor homes have been few. None of these had the combination of ease of use, non-destructive hardware, and prominent display required to appeal to the majority of the patriotic RV community.

A flagpole for this application requires a complete unit that will timelessly and easily attach in a prominent location on a recreational vehicle. It also needs to be compact enough to be stowed in the limited storage areas of such vehicles. The flagpole assembly would need to be capable of being attached to the vehicle without the use of damaging hardware, such as screws, metal clamps, etc. At the same time the flagpole needs to be attached securely enough to withstand heavy winds. The flagpole must also be capable of displaying multiple sizes of flags and banners, and be easily adapted to such.

### DESCRIPTION OF PRIOR ART

Prior art has met some but never all of the aforesaid requirements. Some make use of small flags on hot dog sticks—hardly adequate for the display of the U.S.A Flag. And many display the flag at the rear of the vehicle, hardly prominent. Prior art, specifically US 2006/0053667 display a larger flag, though at the rear of the vehicle. Also it is believed to be quite bulky to stow. U.S. Pat. No. 5,829,731, requires screws to be used into the side of a vehicle.

### SUMMARY

This invention provides a complete flagpole assembly that quickly and easily attaches to the awning arm of most recreational vehicles. It requires no damaging hardware. It is easily attached without tools and causes no damage to surfaces. By attaching to the awning arm the accrued length offers a very prominent display in the front of the vehicle. As it extends beyond the awning edge it is located such as to not hinder view or be of hindrance to passersby. Also by using the existing length of the awning arm the flagpole itself remains reasonably sized to be easily stowed. This invention also allows for use of different sizes of flags and banners, and they are easily adapted without the use of tools.

### BRIEF DESCRIPTION OF DRAWINGS

FIG. 1 is a drawing of the flagpole assembly attached to the awning arm of a recreational vehicle

FIG. 2 is a drawing of the flag assembly including a simulation of an awning arm

FIG. 3 is a drawing of the unique mounting bracket

### DETAILED DESCRIPTION OF THE INVENTION

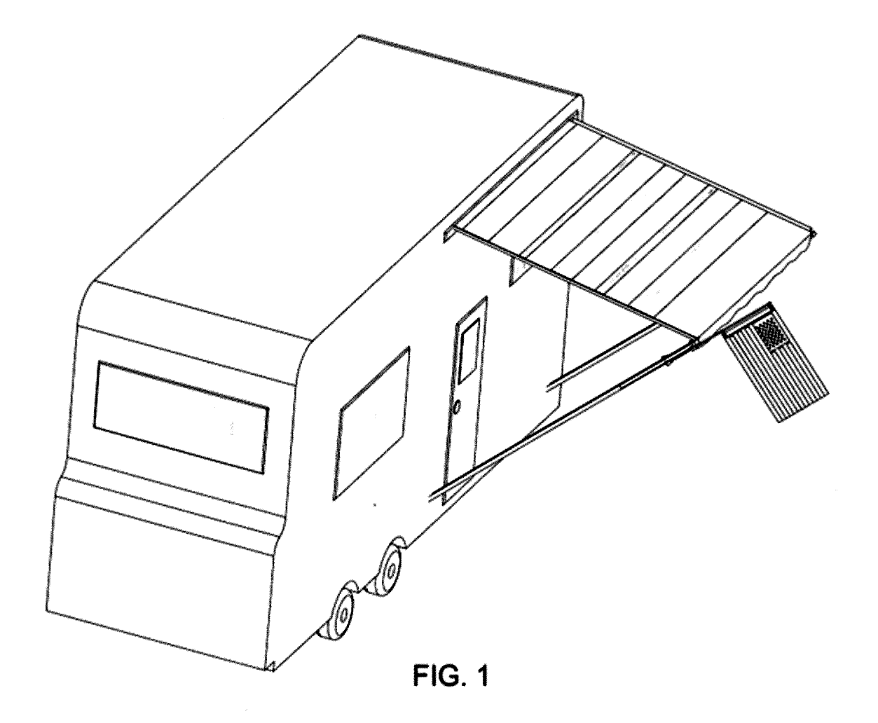

Referring to FIG. 1, the flagpole assembly is shown attached to the awning arm of a simulated recreational vehicle.

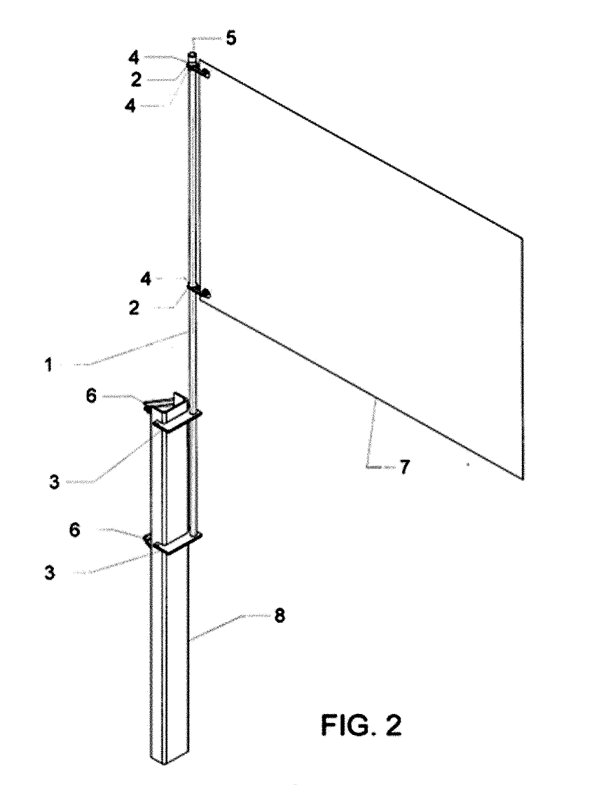

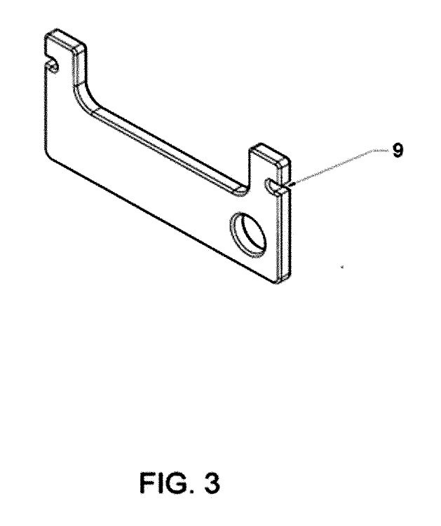

Referring to FIG. 2, the flagpole assembly consists of one flagpole #1, of fiberglass or other suitable material; a quantity of two snap hooks #2, of nylon or similar material; a quantity of two mounting blocks #3 (and FIG. 3), of a suitable non-marring flexible material; a quantity of four hook retainer rings #4, of EPDM; a quantity of one end cap #5, of vinyl; a quantity of two stretch rings #6, of EPDM. Item #7 is a simulation of a flag. Item #8 is a simulation of an awning arm.

The materials can vary, as can the production methods. The materials do need to be weather and UV resistant. The brackets can be molded, formed or machined. Other fastening devices such as hook & loop or other fastening straps could substitute the stretch rings. The brackets can be attached to the pole in many ways including but not limited to glue, pins, setscrews or a press fit.

Still referring to FIG. 2, a quantity of two mounting brackets #3 are fixed to the flagpole #1. A quantity of two snap hooks #2 are slid over the pole #1 and held in place with hook retainer rings #4 situated on either side of each hook. End cap #5, is pressed into place on the upper end of the flagpole #1.

Also in FIG. 2, when attaching the flagpole to the awning arm, the brackets #3 are placed upon and semi-encompassing the awning arm #8. The stretch rings #6 are brought about the arm and secured to the opposing end of the bracket.

What is claimed is:

1. A flagpole assembly that can be attached to the awning arm of a recreational vehicle without the use of damaging hardware.

2. A flagpole assembly of claim 1, comprising:
A pole of flexible yet strong material; two brackets attached to aforesaid pole; two snap hooks for the attachment of a flag or banner, said hooks being held in position on said pole with four hook retainer rings; two stretch rings each being attached one end of aforesaid brackets; and one pole end cap.

3. A flagpole assembly of claim 1 that is quickly, easily, and securely attached without the use of tools.

4. Brackets of said flagpole in claims 1 & 2 are such that the configuration and size can be altered to fit many different awning arms including but not limited to conventional and automatic awnings and awnings that automatically close.
